(19) United States
(12) Patent Application Publication
(10) Pub. No.: US 2019/0284502 A1
(43) Pub. Date: Sep. 19, 2019

(54) SYSTEM AND METHOD FOR REMOVING CHEMICALS AND PESTICIDES OR HARMFUL METALS FROM PLANT BASED EXTRACTS

(71) Applicant: Sauber, Inc., Ukiah, CA (US)

(72) Inventors: Michael Phillip Doyle, Carmel, CA (US); Glenn Richards, Bakersfield, CA (US)

(73) Assignee: Sauber, Inc., Ukiah, CA (US)

(21) Appl. No.: 16/355,737

(22) Filed: Mar. 16, 2019

Related U.S. Application Data
(60) Provisional application No. 62/644,360, filed on Mar. 16, 2018.

(51) Int. Cl. C11B 3/00; C11B 3/12; C11B 3/10

(52) U.S. Cl. CPC C11B 3/001; C11B 3/10; C11B 3/12

(57) ABSTRACT

Disclosed are apparatus, systems, and methods for processing a plant-based extract to remove harmful chemicals or metals. In one embodiment, a method can include exposing the plant-based extract to an acid and basic solution, centrifuging a mixture comprising the plant-based extract and the treatment solution to yield a mixture supernatant, dissolving the mixture supernatant in a solvent to yield a solvent-extract mixture, passing the solvent-extract mixture in liquid or vapor form through a packed column to yield a solvent-extract effluent, and centrifuging at greater than a RCF of 6000 the liquid effluent to yield a processed plant-based extract.

### CROSS-REFERENCES TO RELATED APPLICATIONS

This application claims priority from U.S. Provisional Application No. 62/644,360, filed Mar. 16, 2018 incorporated by reference in its entirety.

### FIELD OF TECHNOLOGY

This disclosure relates generally to systems and methods for processing plant based extracts or oils and, more specifically, to apparatus, systems, and methods for removing pesticides (and other chemicals) or harmful metals from plant based extracts or oils.

### BACKGROUND

Various agricultural crops and products, are routinely treated with agricultural chemicals to promote and enhance growth and the yield of such crops. Frequently, the treated agricultural products or derivatives thereof become contaminated by excessive levels of chemicals so as to constitute a health hazard when consumed. Even when the amount of chemicals used to treat such agricultural products are considered safe for consumption via the route of oral ingestion, such chemicals and agricultural products or derivatives thereof can be considered harmful when such agricultural products are combusted for consumption by inhalation. For example, myclobutanil is a triazole chemical used as a fungicide and approved for use in the European Union, approved by the Environmental Protection Agency (EPA) for use in the United States, and approved for use by many other regions or countries. It is considered only mildly toxic if ingested. However, if this chemical undergoes combustion, it liberates dangerous hydrogen cyanide gas which is highly toxic and can be used for chemical warfare. Such contamination of agricultural products and derivatives thereof by these pesticides and heavy metals is a major public health concern and also a problem of significant economic importance.

A solution is therefore needed which substantially removes these harmful chemicals or metals from such agricultural crops or derivatives thereof without also removing other beneficial organic plant-based compounds from such agricultural crops or derivatives thereof. Such a solution should be generally applicable such that the process can be used on agricultural products or derivatives thereof without concern for how the harmful chemicals or metals ended up on or in the plant or derivatives thereof. For example, the solution should be just as effective in removing pesticides or other harmful chemicals from plants accidentally contaminated by over-spraying as plants contaminated by chemical drift from neighboring crops. Such a solution should also be effective in detecting harmful chemicals passed from mother to daughter plants during propagation. Such a solution should also be cost-effective and easily scalable.

### SUMMARY OF THE INVENTION

Disclosed are methods, systems, and apparatus for processing plant based extracts and, more specifically, to apparatus, systems, and methods for removing pesticides from plant based extracts. In one embodiment, a method of processing a plant-based extract to remove harmful chemicals or metals comprises exposing the plant-based extract to a treatment solution. The treatment solution can comprise an acidic solution, a basic solution, or a combination thereof.

The method can also comprise centrifuging a mixture comprising the plant-based extract and the treatment solution with a centrifuge to yield a mixture supernatant and dissolving the mixture supernatant in a solvent to yield a solvent-extract mixture. In some embodiments, the mixture comprising the plant-based extract and the treatment solution can be centrifuged at a relative centrifugal force (RCF) of 6,000 or above.

The method can also comprise passing the solvent-extract mixture through a packed column to yield a solvent-extract effluent and distilling the solvent-extract effluent using a distillation process to yield a distillation vapor.

The method can also comprise heating the product to create a vapor and then directing the vapor through a second packed column and condensing the distillation vapor passed through the second packed column to yield a condensate. The method can also comprise passing the condensate through a third packed column to yield a liquid effluent and centrifuging the liquid effluent with the centrifuge to yield a processed plant-based extract. In some embodiments, the liquid effluent can be centrifuged at an RCF of 6,000 or above.

In an alternative embodiment, the method can comprise exposing the plant-based extract to a treatment solution. The treatment solution can comprise an acidic solution, a basic solution, or a combination thereof. The method can also comprise centrifuging a mixture comprising the plant-based extract and the treatment solution with a centrifuge to yield a mixture supernatant and dissolving the mixture supernatant in a solvent to yield a solvent-extract mixture. In some embodiments, the mixture comprising the plant-based extract and the treatment solution can be centrifuged at an RCF of 6,000 or above.

The method can also comprise passing the solvent-extract mixture through a packed column to yield a solvent-extract effluent and distilling the solvent-extract effluent using a distillation process to yield a distillation vapor. The method can also comprise condensing the distillation vapor to yield a condensate, passing the condensate through a second packed column to yield a liquid effluent, and centrifuging the liquid effluent with the centrifuge to yield a processed plant-based extract. In some embodiments, the liquid effluent can be centrifuged at an RCF of 6,000 or above.

The Method can also comprise forming a composition of the green matter prior to extraction (extraction with CO2, hydrocarbon solvents or ethanol) and selected activated resins or absorbents, then performing the extraction. The object is to bring the resins or absorbents into close contact with the green matter attracting harmful chemicals.

In all such embodiments, at least one of the first packed column, the second packed column, and the third packed column can be packed with a catalyst, an absorbent, a molecular sieve, or a combination thereof. In addition, the acidic solution can have a pH of about pH 4 and the basic solution can have a pH of about pH 9. Further, the liquids (solutions of oil to treat and a solvent such as ethanol) are processed at specific temperatures to promote bonding of the chemical contaminate and the resin or absorbent. Temperatures may be between minus 20 F to a maximum of the boiling point of the solvent or may be higher if under pressure or processed as a vapor.

Moreover, in certain embodiments, the distillation process can be any method to achieve a vapor stream to pass through a packed section. a short-path wiped film distillation process. In addition, in these and other embodiments, the solvent can be ethanol.

The plant-based extract can be an oil or extract derived from plants from the genus Cannabaceae. In other embodiments, the plant-based extract can be an oil or extract derived from plants from the genus Nicoliana. In certain other embodiments, the plant-based extract can be an oil or extract derived from other herbs.

The harmful chemicals can comprise at least one of bifenazate, pyrethrums, spiromesifen, abamectin, myclobutanil, spinosad, organochlorines, organophosphates, chloroacetanilides, triazines, and carbamates. Moreover, the harmful metals can comprise at least one of arsenic, cadmium, chromium, lead, mercury, manganese, and zinc.

The methods, systems, and apparatus disclosed herein may be implemented in any means for achieving various aspects. Other features will be apparent from the accompanying drawings and from the detailed description that follows.

Metals can be removed from the oils using various methods. One method is to put sodium alginate into a 1% by weight solution and mix it with the oil to get contact with all the oil, allowing the metals to bind to the sodium alginate and then filtering or centrifuging off the aqueous phase or using column separation. As alternatives, instead of sodium alginate other compounds can be used in 1% water mixtures including chitosan, agar, xanthan gum, guar gum and other similar biopolymers.

To increase the absorption of the heavy metals, various nanoparticles can be used to attach to the pesticide such as zinc oxide, aluminum oxide, magnesium oxide and other metal oxides with nanoparticles ranging in size from 5 to 500 nm. A similar method of removal is to allow nanoparticles of iron oxide to attach to the pesticides and then remove them using a fixed or electro magnet. Various inorganic compounds can be used as binding agents to hold the magnetic particles to the pesticide or insecticide. Other methods to remove the metals is to add solutions of diammonium phosphate or ammonium phosphate to the oil and heat the solution to 120° to 140° C. for an hour and the cool to allow the metal to precipitate out as insoluble phosphates. Heat may damage some agricultural oils whereas the biopolymer method can operate at a temperature equal to the heat needed to maintain tallows as liquids or about 70° C.

Other methods to remove metals from oils is to use a solvent to get the oil into a low viscosity solution and then centrifuge to separate out the solids and insoluble which may include metals, metal oxides and gums. Potential solvents include methanol, ethanol, hexane, isopropanol and butanol. For this application or method of metals removal, the centrifuge should preferably be able to achieve a g force in excess of 10,000 g.

Pesticides and fungicides can also be removed by adding to an oil or oil diluted with a solvent like ethanol or acetonitrile, various nanoparticles of metal oxides including titanium dioxide, magnesium oxide, alumina oxides, and silica oxide and then centrifuging or filtering the solution. The nanoparticles have a finite binding energy to the pesticides sufficient to retain the bond during gentle stirring or mixing to permit separation using filtration. The filtration can be enhanced using various powders to prevent plugging the filter media. Filters with nano-sized cartridges and filter media such as nanoceram filters, can be used to separate out the pesticides that the nanoparticles cling to in the solvent solution. As an alternative, nano particles of iron can be used and then removed using a fixed or electro magnet.

Pesticides, Fungicides and Metals can also be removed by adding to an oil or diluted oil with deionized R/O water adjusted to a specific pH with a mild acid or base. This mixture is heated and mixed at a temperature ranging from 70 F to 180 F for 10 to 45 minutes. The mixture is then centrifuged at an RCf greater than 7000 to separate the fractions. The oil fraction once water free, is then passed over ion exchange resin to compete the purification.

### BRIEF DESCRIPTION OF THE DRAWINGS

Example embodiments are illustrated by way of example and are not limited to the FIGURES of the accompanying drawings, in which, like references indicate similar elements.

FIG. 1 illustrates an example method of processing plant based extracts or oils.

### DETAILED DESCRIPTION OF THE PREFERRED EMBODIMENTS

Disclosed are systems, methods, and apparatus for processing plant based extracts or oils and, more specifically, to apparatus, systems, and methods for catalytically removing pesticides or metals from plant based extracts or oils

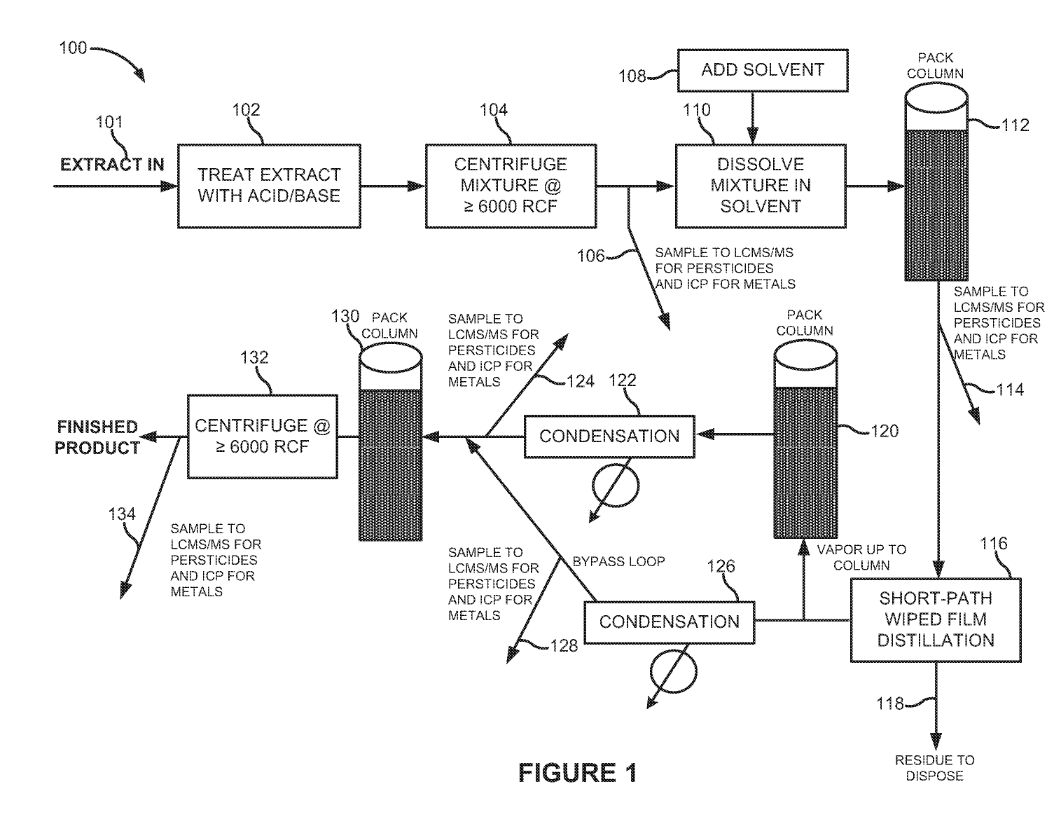

FIG. 1 schematically illustrates a method 100 for processing plant-based extracts 101 in order to remove harmful pesticides or metals from such extracts 101. In one embodiment, the plant matter processed can be plants from the genus Cannabaceae. For example, the plant-based extract 101 can be oils or other types of extracts derived from plants from the genus Cannabaceae. In other embodiments, the plant matter processed can be plants from the genus Nicotiana. For example, the plant-based extract 101 can be oils or other types of extracts derived from plants from the genus Nicotiana. In certain other embodiments, the plant-based extract 101 can be an oil or extract derived from other herbs. In these and other embodiments, the plant-based extract 101 can be oils or extracts which are not predominantly triglycerides or esters or only contain trace amounts of triglycerides or esters.

In these and other embodiments, the harmful chemicals or pesticides removed from the extract 101 using the method 100 disclosed herein can comprise at least one of bifenazate, pyrethrums, spiromesifen, abamectin, myclobutanil, spinosad, organochlorines, organophosphates, chloroacetanilides, triazines, and carbamates. Moreover, the harmful metals removed from the extract 101 using the method 100 disclosed herein can comprise at least one of arsenic, cadmium, chromium, lead, mercury, manganese, and zinc.

The method 100 can be applied to extracts 101 including plant matter (e.g., trim) extracted using supercritical carbon dioxide (CO₂), ethanol, butane, or a combination thereof which yields a crude oil. In one embodiment, the crude oil can be the extract 101 treated using the method 100 described herein. In other embodiments, the extract 100 can refer to crude oil treated further with winterization using ethanol and decarboxylation (involving heating at around 140° C. for approximately 60 minutes) which yields an intermediary oil. In some embodiments, this intermediary oil can be the extract 101 treated using the method 100 described herein. In alternative embodiments, the intermediary oil can be subjected to a distillation process (e.g., a short-path distillation process) which results in a clear oil. In certain embodiments, the clear oil can be the extract 101 treated using the method 100.

As shown in FIG. 1, the method 100 can comprise treating the extract 101 with a treatment solution in step 102. The treatment solution can comprise treating or mixing the extract 101 with an acidic solution followed by mixing the extract 101 treated by the acidic solution with a basic solution. In one embodiment, the acidic solution can comprise citric acid. In this and other embodiments, the acidic solution can be a solution having a solution pH of about pH 4. Moreover, the basic solution can comprise sodium hydroxide (NaOH) in water. In this and other embodiments, the basic solution can be a solution have a solution pH of about pH 9. The extract 101 can be treated with the acidic solution followed by the basic solution at between approximately 65° C. and 80° C.

In another embodiment, step 102 can comprise treating or mixing the extract 101 with a treatment solution comprising citric acid and phosphoric acid in water. In this and other embodiments, an absorbent can be added to the mixture comprising the treatment solution and the extract 101. The absorbent can include clays, gels, or a combination thereof. In one embodiment, the clay can be sodium bentonite clay provided by Clariant. In this and other embodiments, the gels can be silica gels such as TRISYL® silica gels provided by W. R. Grace.

The method 100 can further comprise centrifuging a mixture comprising the plant-based extract 101 and the treatment solution with a centrifuge to yield a mixture supernatant in step 104. In some embodiments, the mixture comprising the plant-based extract and the treatment solution can be centrifuged at a relative centrifugal force (RCF) of 6000 or above. In one embodiment, the centrifuge can be a benchtop or standalone centrifuge provided by Thermo Scientific®.

FIG. 1 illustrates that the method 100 can also comprise testing an aliquot or sample of the mixture supernatant at this point in step 106. Step 106 can involve testing or analyzing the aliquot or sample of the mixture supernatant using liquid chromatography tandem-mass spectrometry (LCMS/MS) using a triple quadrupole mass spectrometer to detect for chemicals such as pesticides. Step 106 can also involve testing or analyzing the aliquot or sample of the mixture supernatant using inductively coupled plasma mass-spectrometry (ICP-MS) to detect for heavy metals. This step can be used as part of an ongoing check to determine if the system or method 100 is indeed removing harmful chemicals or heavy metals from the extract 101.

The method 100 can further comprise adding a solvent to the mixture supernatant in step 108. The mixture supernatant can then be allowed to dissolve in the solvent to yield a solvent-extract mixture in step 110. In one embodiment, the solvent can be ethanol mixed with water. The solvent can comprise a water-ethanol mixture of between 10% to 30% water to 90% to 70% ethanol (e.g., weight/weight %). In all such embodiments, the amount of water does not exceed 30%. In one preferred embodiment, the solvent comprises 90% ethanol and 10% water.

The method 100 can also comprise passing the solvent-extract mixture through a packed column comprising a catalyst, an absorbent, a molecular sieve, or a combination thereof in step 112. In one embodiment, the catalyst can be a zinc-containing catalyst such as a zinc-containing Zeolite Socony Mobil-5 (ZSM-5) catalyst. The absorbent can include clays, gels, or a combination thereof. In one embodiment, the clay can be sodium bentonite clay provided by Clariant. In this and other embodiments, the gels can be silica gels such as TRISYL® silica gels provided by W. R. Grace or sSORB® silica gels provided by Interra Global Corporation. Moreover, in these and other embodiments, the molecular sieves can include mSORB® molecular sieves provided by Interra Global Corporation. Passing the solvent-extract mixture through the packed column can result in a solvent-extract effluent.

As shown in FIG. 1, the method 100 can also comprise testing an aliquot or sample of the solvent-extract effluent at this point in step 114. Step 114 can involve testing or analyzing the aliquot or sample of the solvent-extract effluent using LCMS/MS (e.g., using a triple quadrupole mass spectrometer) to detect for chemicals such as pesticides. Step 114 can also involve testing or analyzing the aliquot or sample of the solvent-extract effluent using ICP-MS to detect for heavy metals.

The method 100 can also comprise distilling the solvent-extract effluent using a distillation process in step 116. In one embodiment, the distillation process can be a short-path distillation process. More specifically, the distillation process can be a short-path wiped film distillation process using a wiped film evaporator. For example, a rotating wiper system can distribute the solvent-extract effluent to a film on an inner surface of a heated pipe. The wiping system can speed up the evaporation process by keeping the effluent turbulent such that heat transfer and mass transfer are optimized.

Method 100 can further comprise discarding the residue from the distillation process in step 118. In one embodiment of the method 100 shown in FIG. 1, the distillation vapor from the distillation process in step 116 can be passed to or directed into another packed column comprising a catalyst, an absorbent, a molecular sieve, or a combination thereof in step 120. In one embodiment, the catalyst can be a zinc-containing catalyst such as a zinc-containing ZSM-5 catalyst or a nickel/molybdenum (NiMo) catalyst. The absorbent can include clays, gels, or a combination thereof. In one embodiment, the clay can be sodium bentonite clay provided by Clariant. In this and other embodiments, the gels can be silica gels such as TRISYL silica gels provided by W. R. Grace or sSORB® silica gels provided by Interra Global Corporation. Moreover, in these and other embodiments, the molecular sieves can include mSORB@molecular sieves provided by Interra Global Corporation.

At this point, the method 100 can further comprise condensing the distillation vapor passed through the packed column to yield a condensate in step 122. In one embodiment, the method can also comprise testing an aliquot or sample of the condensate in step 124. Step 124 can involve testing or analyzing the aliquot or sample of the condensate using LCMS/MS (e.g., using a triple quadrupole mass spectrometer) to detect for chemicals such as pesticides. Step 124 can also involve testing or analyzing the aliquot or sample of the condensate using ICP-MS to detect for heavy metals.

The method 100 can also comprise passing the condensate through yet another packed column to yield a liquid effluent in step 130. The packed column can comprise a catalyst, an absorbent, a molecular sieve, or a combination thereof. In one embodiment, the catalyst can be a zinc-containing catalyst such as a zinc-containing ZSM-5 catalyst. The absorbent can include clays, gels, or a combination thereof. In one embodiment, the clay can be sodium bentonite clay provided by Clariant. In this and other embodiments, the gels can be silica gels such as TRISYL® silica gels provided by W. R. Grace or sSORB® silica gels provided by Interra Global Corporation. Moreover, in these and other embodiments, the molecular sieves can include mSORB® molecular sieves provided by Interra Global Corporation.

The method 100 can further comprise centrifuging the liquid effluent with a centrifuge in step 132 to yield a processed plant-based extract in the form of the supernatant. In some embodiments, the liquid effluent can be centrifuged at an RCF of 6000 or above. At this point, the processed plant-based extract or oil can be tested once again in step 134. For example, step 134 can involve testing or analyzing the aliquot or sample of the processed plant-based extract or oil using LCMS/MS (e.g., using a triple quadrupole mass spectrometer) to detect for chemicals such as pesticides. Step 134 can also involve testing or analyzing the aliquot or sample of the processed plant-based extract using ICP-MS to detect for heavy metals.

In an alternative embodiment of the method 100 shown in FIG. 1, the distillation vapor from step 116 can be condensed using a condenser to yield a condensate in step 126. The condensate can be tested or analyzed in step 128. For example, step 128 can involve testing or analyzing the aliquot or sample of the condensate using LCMS/MS (e.g., using a triple quadrupole mass spectrometer) to detect for chemicals such as pesticides. Step 126 can also involve testing or analyzing the aliquot or sample of the condensate using ICP-MS to detect for heavy metals. The condensate can then be passed to the packed column in step 130 as described above. In this embodiment of the method 100, the step of passing the distillation vapor to vapor column is bypassed.

Variations of the method 100 disclosed herein have been shown to reduce amounts of pesticides such as pyrethrums by as much as 98% to 99% after treatment (e.g., 1222 ppm of pyrethrums before treatment to 20.94 ppm of pyrethrums after treatment and 1461 ppm of pyrethrums before treatment to 18.79 ppm after treatment) using certain steps of the method 100. In addition, variations of the method 100 disclosed herein have been shown to reduce amounts of pesticides such as spinosad by as much as 90% after treatment (e.g., 1.20 ppm of spinosad before treatment to 0.125 ppm of spinosad after treatment). Furthermore, variations of the method 100 disclosed herein have also been shown to reduce amounts of pesticides such as bifenazate by as much as 94% (e.g., 23.50 ppm of bifenazate before treatment to 1.321 ppm of bifenazate after treatment).

### Additional Disclosure

1. A method of processing a plant-based extract to remove harmful chemicals or metals, comprising:
exposing the plant-based extract to a treatment solution, wherein the treatment solution comprises an acidic solution, a basic solution, or a combination thereof;
centrifuging a mixture comprising the plant-based extract and the treatment solution with a centrifuge to yield a mixture supernatant.
dissolving the mixture supernatant in a solvent to yield a solvent-extract mixture;
passing the solvent-extract mixture through a first packed column to yield a solvent-extract effluent;
heating the effluent to create a vapor and then directing the vapor through a second packed column and condensing the distillation vapor passed through the second packed column to yield a condensate;
passing the condensate through a third packed column to yield a liquid effluent and
centrifuging the liquid effluent with the centrifuge to yield a processed plant-based extract.

2. The method of item 1 above, wherein at least one of the first packed column, the second packed column, and the third packed column comprises a catalyst, an absorbent, a molecular sieve, or a combination thereof.

3. The method of item 1 above, wherein the acidic solution has a pH of about pH 4 and the basic solution has a pH of about pH 9.

4. The method of item 1 above, wherein the mixture comprising the plant-based extract and the treatment solution is chilled to below 40 F and processing is maintained at this temperature.

5. The method of item 1 above, wherein the mixture comprising the plant-based extract and the treatment solution is centrifuged at a relative centrifugal force (RCF) of 6000 or above.

6. The method of item 1 above, wherein the liquid effluent is centrifuged at a relative centrifugal force (RCF) of 6,000 or above.

7. The method of item 1 above, wherein the plant-based extract is an oil or extract derived from plants from the genus Cannabaceae.

8. The method of item 1 above, wherein the solvent is ethanol.

9. The method of item 1 above, wherein the harmful chemicals comprise at least one of bifenazate, pyrethrums, spiromesifen, abamectin, myclobutanil, spinosad, organochlorines, organophosphates, chloroacetanilides, triazines, and carbamates.

10. The method of item 1 above, wherein the harmful metals comprise at least one of arsenic, cadmium, chromium, lead, mercury, manganese, and zinc.

11. A method of processing a plant-based extract to remove harmful chemicals or metals, comprising:
exposing the plant-based extract to a treatment solution, wherein the treatment solution comprises an acidic solution, a basic solution, or a combination thereof;
centrifuging a mixture comprising the plant-based extract and the treatment solution with a centrifuge to yield a mixture supernatant;
dissolving the mixture supernatant in a solvent to yield a solvent-extract mixture; passing the solvent-extract mixture through a first packed column to yield a solvent-extract effluent;
heating the effluent to create a vapor and then directing the vapor through a second packed column and condensing the distillation vapor passed through the second packed column to yield a condensate;
passing the condensate through a third packed column to yield a liquid effluent; and centrifuging the liquid effluent with the centrifuge to yield a processed plant-based extract.

12. The method of item 11 above, wherein at least one of the first packed column and the second packed column comprises a catalyst, an absorbent, a molecular sieve, or a combination thereof.

13. The method of item 11 above, wherein the acidic solution has a pH of about pH 4 and the basic solution has a pH of about pH 9.

14. The method of item 11 above, wherein the distillation process is a short-path wiped film distillation process.

15. The method of item 11 above, wherein the mixture comprising the plant-based extract and the treatment solution is centrifuged at a relative centrifugal force (RCF) of 6,000 or above.

16. The method of item 11 above, wherein the liquid effluent is centrifuged at a relative centrifugal force (RCF) of 6,000 or above.

17. The method of item 11 above, wherein the plant-based extract is an oil or extract derived from plants from the genus Cannabaceae.

18. The method of item 11 above, wherein the solvent is ethanol.

19. The method of item 11 above, wherein the harmful chemicals comprise at least one of bifenazate, pyrethrums, spiromesifen, abamectin, myclobutanil, spinosad, organochlorines, organophosphates, chloroacetanilides, triazines, and carbamates.

20. The method of item 11 above, wherein the harmful metals comprise at least one of arsenic, cadmium, chromium, lead, mercury, manganese, and zinc.

21. The method of item 11 above wherein the metals are removal using a biopolymer from the group of sodium alginate, xanthan gum, guar gum or xanthan gum.

22. The method of item 11 above wherein the harmful chemical is a pesticide;
removing the pesticide using magnetic nanoparticles attached to the pesticide.

23. The method of item 11 above wherein the harmful chemical is a pesticide;

removing the pesticide using FX24 or FX25 which comprise bentonite and silica particles in the 6 to 20 micron size.

A number of embodiments have been described. Nevertheless, it will be understood that various modifications may be made without departing from the spirit and scope of the claimed invention. In addition, the logic flows depicted in the FIGURES do not require the particular order shown, or sequential order, to achieve desirable results. In addition, other steps may be provided, or steps may be eliminated, from the described flows, and other components may be added to, or removed from, the described apparatus. Accordingly, other embodiments are within the scope of the following claims.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation. Unless defined otherwise, all technical and scientific terms used herein have the same meaning as commonly understood by one of ordinary skill in the art to which this invention belongs.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

We claim:

1. A method of processing a plant-based extract to remove harmful chemicals or metals, comprising:
exposing the plant-based extract to a treatment solution, wherein the treatment solution comprises an acidic solution, a basic solution, or a combination thereof;
centrifuging a mixture comprising the plant-based extract and the treatment solution with a centrifuge to yield a mixture supernatant;
dissolving the mixture supernatant in a solvent to yield a solvent-extract mixture;
passing the solvent-extract mixture through a first packed column to yield a solvent-extract effluent;
heating the effluent to create a vapor and then directing the vapor through a second packed column and condensing the distillation vapor passed through the second packed column to yield a condensate;
passing the condensate through a third packed column to yield a liquid effluent; and
centrifuging the liquid effluent with the centrifuge to yield a processed plant-based extract.

2. The method of claim 1, wherein at least one of the first packed column, the second packed column, and the third packed column comprises a catalyst, an absorbent, a molecular sieve, or a combination thereof.

3. The method of claim 1, wherein the acidic solution has a pH of about pH 4 and the basic solution has a pH of about pH 9.

4. The method of claim 1, wherein the mixture comprising the plant-based extract and the treatment solution is chilled to below 40 F and processing is maintained at this temperature.

5. The method of claim 1, wherein the mixture comprising the plant-based extract and the treatment solution is centrifuged at a relative centrifugal force (RCF) of 6000 or above.

6. The method of claim 1, wherein the liquid effluent is centrifuged at a relative centrifugal force (RCF) of 6,000 or above.

7. The method of claim 1, wherein the plant-based extract is an oil or extract derived from plants from the genus Cannabaceae.

8. The method of claim 1, wherein the solvent is ethanol.

9. The method of claim 1, wherein the harmful chemicals comprise at least one of bifenazate, pyrethrums, spiromesifen, abamectin, myclobutanil, spinosad, organochlorines, organophosphates, chloroacetanilides, triazines, and carbamates.

10. The method of claim 1, wherein the harmful metals comprise at least one of arsenic, cadmium, chromium, lead, mercury, manganese, and zinc.

11. A method of processing a plant-based extract to remove harmful chemicals or metals, comprising:
exposing the plant-based extract to a treatment solution, wherein the treatment solution comprises an acidic solution, a basic solution, or a combination thereof;
centrifuging a mixture comprising the plant-based extract and the treatment solution with a centrifuge to yield a mixture supernatant;
dissolving the mixture supernatant in a solvent to yield a solvent-extract mixture;
passing the solvent-extract mixture through a first packed column to yield a solvent-extract effluent;
heating the effluent to create a vapor and then directing the vapor through a second packed column and condensing the distillation vapor passed through the second packed column to yield a condensate;
passing the condensate through a third packed column to yield a liquid effluent; and
centrifuging the liquid effluent with the centrifuge to yield a processed plant-based extract.

12. The method of claim 11, wherein at least one of the first packed column and the second packed column comprises a catalyst, an absorbent, a molecular sieve, or a combination thereof.

13. The method of claim 11, wherein the acidic solution has a pH of about pH 4 and the basic solution has a pH of about pH 9.

14. The method of claim 11, wherein the distillation process is a short-path wiped film distillation process.

15. The method of claim 11, wherein the mixture comprising the plant-based extract and the treatment solution is centrifuged at a relative centrifugal force (RCF) of 6,000 or above.

16. The method of claim 11, wherein the liquid effluent is centrifuged at a relative centrifugal force (RCF) of 6,000 or above.

17. The method of claim 11, wherein the plant-based extract is an oil or extract derived from plants from the genus Cannabaceae.

18. The method of claim 11, wherein the solvent is ethanol.

19. The method of claim 11, wherein the harmful chemicals comprise at least one of bifenazate, pyrethrums, spiromesifen, abamectin, myclobutanil, spinosad, organochlorines, organophosphates, chloroacetanilides, triazines, and carbamates.

20. The method of claim 11, wherein the harmful metals comprise at least one of arsenic, cadmium, chromium, lead, mercury, manganese, and zinc.

21. The method of claim 11 wherein the metals are removal using a biopolymer from the group of sodium alginate, xanthan gum, guar gum or xanthan gum.

22. The method of claim 11 wherein the harmful chemical is a pesticide;
removing the pesticide using magnetic nanoparticles attached to the pesticide.

23. The method of claim 11 wherein the harmful chemical is a pesticide;
removing the pesticide using FX24 or FX25 which comprise bentonite and silica particles in the 6 to 20 micron size.
